(19) United States
(12) Patent Application Publication
(10) Pub. No.: US 2023/0056269 A1
(43) Pub. Date: Feb. 23, 2023

(54) SMART STIR FRYER

(71) Applicant: REBEL FOODS PRIVATE LIMITED, Pune (IN)

(72) Inventors: Uday MAHAJAN, Pune (IN); Ashish Deelip GHATGE, Aurangabad (IN); Neelaabh Rabindra PAL, Bhagalpur (IN); Soumyadeep BARMAN, Kolkata (IN); Vijay Premshankar PANDEY, Mumbai (IN); Sudeshna TRILOK, Bangalore (IN); Ankush GROVER, Jalandhar City (IN)

(73) Assignee: REBEL FOODS PRIVATE LIMITED, Pune (IN)

(21) Appl. No.: 17/797,825

(22) PCT Filed: Apr. 12, 2021
(86) PCT No.: PCT/IB2021/053007

§ 371 Date: Aug. 5, 2022

(30) Foreign Application Priority Data
Apr. 13, 2020 (IN) 202021010894

(51) Int. Cl. A47J 37/12; G05D 23/19

(52) U.S. Cl. CPC A47J 37/1266; G05D 23/1917; A47J 37/1228

(57) ABSTRACT

A stir fryer (1) which includes a pot (2) having a cavity to place ingredients to stir fry the ingredients, and which can be rotated, a heating medium (3) functionally coupled to the pot (2) to heat the pot (2), a rotational means (4) functionally coupled to the pot (2) to rotate the pot (2) symmetrically or eccentrically about an axis, and a rotation regulator (5) which regulates the rotational unit/component/etc. (4) to further regulate speed of rotation of the pot (2).

### FIELD OF INVENTION

The present invention relates to stir fryers. More specifically the invention relates to stir fryer which has automated means to automate functionalities required for stir frying operations.

### BACKGROUND OF INVENTION

Stir frying is a cooking technique in which ingredients are fried in a small amount of very hot oil while being stirred or tossed in a wok. Firstly, the wok is heated to a high temperature, and just as or before it smokes, a small amount of cooking oil is added down the side of the wok, followed by dry seasonings such as ginger, garlic, scallions, or shallots. The seasonings are tossed with a spatula until they are fragrant, then other ingredients, mostly the main ingredients like vegetables, noodles, meat, etc. When the main ingredients are cooked or nearly cooked, combinations of sauces and spices are added followed by thickeners.

Stir frying technique has a specific way of cooking and have multiple steps involved. It essentially involves heating the wok to appropriate temperature, adding oil in a specific fashion, and further following various steps for adding ingredients while regularly tossing the ingredients at specific times to efficiently cook a dish. Hence, chefs are required to make the dish correctly. Also, it is to be noted that only one Chef can handle one wok at a time because his regular involvement is required to complete the cooking of a dish.

In today's time, when it is desired to have cost efficiency and high throughput is required in commercial kitchens, to be cost competitive, it is desired that such cooking process should be automated, as well as, deskilled, so that specialized Chef may not be required to carry out such cooking techniques.

In one prior art patent W02015196891A1 titled “Multi-functional stir-fryer”, a multi-functional stir-fryer is disclosed which includes an inner pan, and a main machine driving and controlling the operation of the inner pan, wherein a detachable shaft coupling is created between the inner pan and the main machine. The main machine comprises a main machine frame, a flipping mechanism used for adjusting and limiting the angle of inclination of the inner pan, a driving mechanism driving the rotation of the inner pan by connection to a connector at a bottom part of the inner pan, a pan seat mounting the inner pan, an electromagnetic heating mechanism with a separable zone heating the inner pan which is close to the surface of the inner pan, and a control circuit. The control circuit is respectively coupled to the driving mechanism and the electromagnetic heating mechanism; the pan seat has a movable shaft coupling with the support frame via the flipping mechanism, and the driving mechanism is fixedly connected to the pan seat; and the electromagnetic heating mechanism is fixed on the pan seat.

Another prior art patent U.S. Pat. No. 9,775,466B2, titled “Automatic Stir-fryer” discloses an automatic stir-fryer comprising a machine stand, a base pivotably provided on the machine stand, a rotary shaft providing rotary power and connected to a stir-frying rotary tank containing foodstuffs; a stove unit disposed on the base and situated right below the stir-frying rotary tank; a tilting unit pivotably disposed on the base; a receiving tank provided in the machine stand for receiving the cooked foodstuffs; a cleaning unit assembled on the machine stand and corresponding to the stir-frying rotary tank after tilting by the tilting unit for water cleaning the stir-frying rotary tank; a control unit vertically disposed on the machine stand and provided with an control panel for controlling the operating time of the automatic stir-fryer and the temperature of the stove unit.

Another prior art exists US20170354287A1, titled “Automatic stir-fryer” discloses an automatic stir-fryer comprising a machine stand, a base pivotably provided on the machine stand, a rotary shaft providing rotary power and connected to a stir-frying rotary tank containing foodstuffs, a high-frequency induction heating unit coaxially covering the stir-frying rotary tank, a tilting unit pivotably disposed on the base, a receiving tank provided on the machine stand for receiving the cooked foodstuffs and controlled by an automatic push rod to move forward and backward, a cleaning unit assembled on the machine stand and corresponding to the stir-frying rotary tank after tilting by the tilting unit for water cleaning the stir-frying rotary tank, a control unit vertically disposed on the machine stand and provided with an control panel for controlling the operating time of the automatic stir-fryer and the temperature of the high-frequency induction heating unit.

The stir fryer disclosed by the prior arts has limitation to efficiently cook a substantial number of dishes, as each dish has different requirements of rotating the pot, and different requirement of tilt. Also, these devices may still require specialized Chefs to cook, as there are no mechanisms provided to enable a Novice cook complex stir frying dishes, Hence, a lot is left to be desired by the prior arts, and they do not solve the problem of commercial kitchens who have to optimize costs, standardize processes in a widely competitive market.

### OBJECTIVE OF INVENTION

The objective of the invention is to provide a stir fryer which do not require high skills to handle and to cook complex dishes consistently, and which reduce cooking efforts of a user by automating multiple aspects of stir-frying operations.

### SUMMARY OF INVENTION

The objective of the invention is achieved by a stir fryer according to claim 1.

The stir fryer includes a pot having a cavity to place ingredients to stir fry the ingredients, which can be rotated, a heating medium functionally coupled to the pot to heat the pot, a rotational means functionally coupled to the pot to rotate the pot symmetrically or eccentrically about an axis, and a rotation regulator which regulate the rotational means to further regulate speed of rotation of the pot. Different dishes require different speed of rotation while cooking to optimally cook them to desired perfection. By having a speed regulator to optimize speed of rotation of the pot, same stir fryer can be utilized for various dishes to provide an optimal cooking to each type of the dishes. Also, varied speed of rotation shall be helpful to carry out various type of cooking operations like stir frying, steaming, pan frying, deep frying, poaching, boiling, braising, searing, stewing, making soup, smoking and roasting nuts, etc. Hence, due to varying speed of rotation the device can be utilized for various kind of cooking operations, and not just stir frying.

According to another embodiment of the stir fryer, the stir fryer includes a tilting means which tilts the pot at a tilt angle up to one hundred and eighty degree from a normal of a base on which the stir fryer is placed. Different tilt angles of the pot are desired for carrying out different kind of cooking operations, and also for cooking different type of dishes. This embodiment helps to achieve different gradations of tilt angles while carrying out a cooking operation. In furtherance, the tilting can also be useful not just during the cooking operation, but also during dishing out the dish, or cleaning the pot.

According to yet another embodiment of the stir fryer, the stir fryer includes a locking means to lock the pot at a predefined tilt angle, or to unlock the pot to be released from the predefined tilt angle. Locking means are useful for keeping the pot locked at a desired angle. In absence of such locking means, substantial manual efforts are required to hold the pot at a desired tilt angle.

According to one embodiment of the stir fryer, the stir fryer includes an automatic actuator which receives and processes a tilt trigger, and accordingly actuates the tilting means. This shall further help to reduce the manual efforts applied for tilting the pot.

According to another embodiment of the stir fryer, the stir fryer includes one or more ingredients dispensers placed in proximity to the pot and functionally coupled to the pot to dispense ingredients into the cavity of the pot. This embodiment shall further simplify handling of the ingredients, where the ingredients can directly be dispensed into the pot with no handling of the ingredients manually. This shall reduce wastage of the ingredients which may occur due to mishandling of the ingredients by the user of the stir fryer.

According to yet another embodiment of the stir fryer, the stir fryer includes an ingredient dispense controller which receives a dispense trigger and controls dispensing of the ingredients into the pot. This helps to further automate specific amount of dispensing of the ingredients. In case, if the dispensers are manually operated, there can be chances of improper estimation of the ingredients which may lead to undesired taste of the dish. This embodiment further helps to standardize the cooking operations while using the stir fryer.

According to one embodiment of the stir fryer, wherein the one or more ingredients dispensers are adapted to tilt along with the tilting of the pot. This embodiment shall further be helpful in timely handling of the ingredients into the pot at an appropriate time when they are required to be placed. In case, if the dispensers do not tilt along with the dispenser, the user of the stir fryer has to keep on tilting the pot to a desired angle where the dispenser can directly pour in the ingredient into the pot or the user has to keep on moving the dispenser to a required position for such placement of the ingredients. This would have increased the human efforts, as well, it shall hamper the cooking operation, which may impact the quality of the cooked dish.

According to another embodiment of the stir fryer, the stir fryer includes one or more changeable tossing or stirring arrangements placed inside the cavity of the pot. These different type of tossing or stirring arrangements are helpful to provide an appropriate tossing for specific type of dishes.

According to yet another embodiment of the stir fryer, the stir fryer includes one or more changeable tossing or stirring arrangements placed in proximity to the cavity of the pot and a head of the tossing or stirring arrangement is moved to placed inside the cavity of the pot to toss the ingredients while carrying out a cooking operation. This embodiment provides a different arrangement for tossing which keeps the space inside the cavity free from hindrances, and also provide for quick replacement of the tossing or stirring arrangement during the cooking operation.

According to one embodiment of the stir fryer, the stir fryer includes a tossing controller to receives and processes a tossing trigger and further controls movement of the tossing or stirring arrangements into the cavity of the pot. This embodiment can be helpful to vary the movement of the tossing or stirring arrangement is appropriate fashion, and with a specific speed, according to a desired cooking operation or during a specific cooking step.

According to another embodiment of the stir fryer, wherein the one or more tossing or stirring arrangements are adapted to tilt along with the tilting of the pot. This embodiment is helpful to keep the tossing equipment aligned to the cavity of the pot at all positions of the pot.

According to yet another embodiment of the stir fryer, the stir fryer includes a heat regulator which receives and processes a heat trigger and regulates the heating medium by varying heating quantum or switch on or switch off of the heating medium. This helps in efficient control of the heating medium for cooking a dish at an appropriate temperature.

According to one embodiment of the stir fryer, the stir fryer includes one or more cleaning fluid dispenser placed in proximity to the pot and functionally coupled to the pot to dispense cleaning fluid into the cavity of the pot. This embodiment provides for an efficient way to clean the pot after cooking.

According to another embodiment of the stir fryer, the stir fryer includes a cleaning dispense controller which receives a cleaning trigger and controls at least one of amount of dispensing of the cleaning fluid or pressure of dispensing of the cleaning fluid from the one of more cleaning fluid dispensers, or combination thereof. This helps in cleaning the pot with better efficiency along with optimization of cleaning resources,

According to yet another embodiment of the stir fryer, wherein the one or more cleaning fluid dispensers are adapted to tilt along with the tilting of the pot. This helps in efficient handling of cleaning resources and the pot while the cleaning of the pot is being carried out.

According to one embodiment of the stir fryer, the stir fryer includes a microcontroller which generates at least the tilt trigger, a rotational trigger, the dispense trigger, the tossing trigger, the cleaning trigger, or the heat trigger, or combination thereof. The rotational trigger is received by the rotation regulator to regulate rotational means. This embodiment helps to further automate the functioning of the stir fryer by further reducing human interventions.

According to another embodiment of the stir fryer, the stir fryer includes one or more temperature sensors which measures temperature at a given point of time, and generates a temperature data. The microcontroller receives and processes the temperature data and generates the heat trigger based on such processing.

According to one embodiment of the stir fryer, the stir fryer includes an input unit which receives a selection input to select a recipe from a selection of recipes. The microcontroller receives and processes the selection input, optionally along with the temperature data, and generates at least the tilt trigger, the rotational trigger, the dispense trigger, the tossing trigger, or a heat trigger, or combination thereof.

According to another embodiment of the stir fryer, wherein the input unit receives a portion input. The portion input relates to a quantity of recipe chosen to be cooked during a cooking operation. The microcontroller receives and processes the portion input along with the selection input, and optionally along with the temperature data, and generates at least the tilt trigger, the rotational trigger, the dispense trigger, the tossing trigger, the cleaning trigger, or the heat trigger, or combination thereof.

### BRIEF DESCRIPTION OF DRAWINGS

FIG. 1 illustrates a schematic diagram of a stir fryer along with various automation elements, according to an exemplary embodiment of the invention.

FIG. 2 illustrates a side view of another stir fryer at a first position of tilt.

FIG. 3 illustrates the side view of the stir fryer at a second position of tilt.

FIG. 4 illustrates the side view of stir fryer having ingredients dispensers decoupled to cavity of the pot.

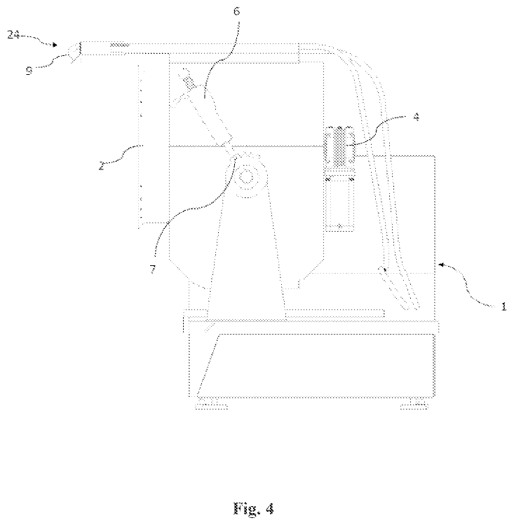

FIG. 5 illustrates the stir fryer with a tossing arrangement for cooking fried rice inside the cavity of the pot.

FIG. 6 illustrates the stir fryer with a tossing arrangement for cooking noodles inside the cavity of the pot.

FIG. 7 illustrates the stir fryer with a stirring arrangement for cooking soup inside the cavity of the pot.

The figures depict embodiments of the disclosure for purposes of illustration only. One skilled in the art will readily recognize from the following description that alternative embodiments illustrated herein may be employed without departing from the principles of the disclosure described herein.

### DETAILED DESCRIPTION

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

The invention focuses on providing a stir fryer capable of heating and tossing food in order to replicate and deskill the process of Wok cooking. Its capabilities include, but are not limited to, stir frying, steaming, pan frying, deep frying, poaching, boiling, braising, searing, stewing, making soup, smoking and roasting nuts.

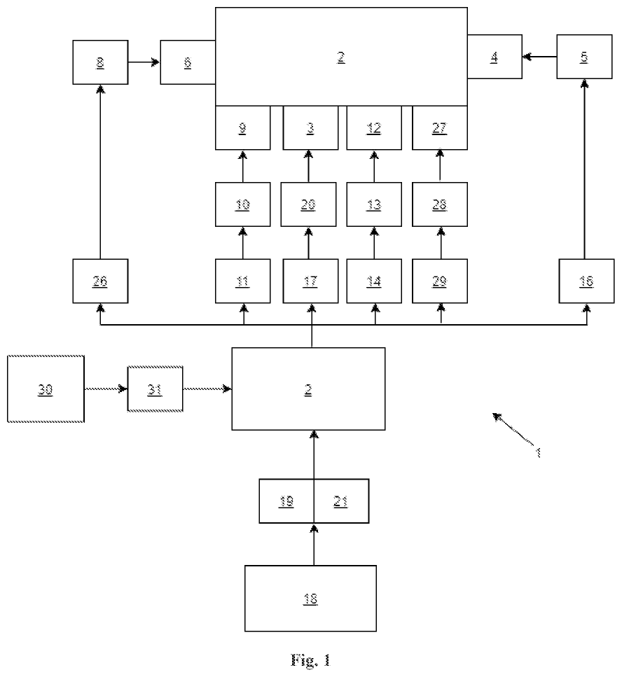

FIG. 1. illustrates schematic representation of the stir fryer 1 along with all the automation components of it. The stir fryer 1 has a pot 2 into which the ingredients are put to cook a dish. The stir fryer 1 includes a heating means 3 which is placed in proximity to the pot 2 to heat the pot 2. The pot 2 also includes a rotation means 4 which rotates the pot 2 rotate symmetrically or eccentrically about an axis. To regulate speed of rotation of the pot 2, a rotation regulator 5 is provided. The rotation regulator 5 receive a rotational trigger 16 to vary the speed of rotation of the pot 2. It is pertinent to be noted that the varying of the speed of rotation can be according to various steps of the cooking. If a particular step of cooking required a different speed of rotation of the pot, the speed can be varied by providing rotational trigger 16 to the rotation regulator 5. Accordingly, during the complete cooking cycle, multiple times the rotation trigger 5 can be provided to vary speed of rotation as per desired speed of rotation required for each of the cooking step. It is pertinent to be noted that the rotational trigger 5 can be provided through manual means, such a rotor which can be rotated manually by the user to rotate the pot 2. Also, the rotational trigger 5 can be provided through automated means through a microcontroller 15, as it is shown in the current embodiment of FIG. 1.

The stir fryer 1 also has a tilting means 6 which is used to tilt the pot 2. Tilting of the pot 2 can be required during various steps of cooking, such as during placement of the ingredients, and to dish out the cooked dish. Also, during cleaning of the pot 2 also the tilting of the pot 2 shall be required. It is pertinent to be noted that some of the dishes shall require tilting of the pot at a particular gradient to have most effective cooking. The tilting means 6 shall be helpful to change the gradient at requisite angle as per requirement of a dish to be cooked. For some dishes, even the gradient of the pot is further required to be changed during different processing steps. The tilting means 6 comes handy for such tilting of the pot 2 multiple times at short durations during the cooking cycle of a dish.

The tilting means 1 is capable to rotate the pot 2 at a tilt angle up to one hundred and eighty degree from a normal of a base on which the stir fryer 1 is placed.

In furtherance, a locking means 7 is also provided with the stir fryer 1, which locks the pot 2 at a particular gradient. In absence of locking, the user would have to hold the pot 2 at a specific gradient, which will increase human effort for holding the pot, and also the user has to keep on checking for the gradient should not change while he is holding the pot 2. Even though, such embodiment is possible to have the tilting means 6 without locking means 6, however, it shall increase human efforts.

The tilting of the pot can be manually carried out. However, to further reduce the human efforts, an automatic actuator is provided which receives and process a tilt trigger 26, and adapted to actuate the tilting means 6. This tilt trigger 26 can be manually provided through electrical interface where a push button or rotor, or any other kind of trigger generating input means can be provided which can be used to provide user input to change the tilt angle of the pot on receiving such user input from the electrical interface. The tilt trigger 26 generation can be further automated which can be generated by the microcontroller 15 directly based on a particular dish to be cooked. Current embodiment, provides the tilt trigger 26 to the tilting means 6 from the microcontroller 15. Such generation of tilt trigger 26 automatically further deskills the whole cooking process.

The stir fryer 1 is further provided with ingredient dispensers 9 which are placed near to the opening of the pot, so that the ingredients from the dispenser can directly and easily dispensed into the cavity of the pot 2. There can be one ingredient dispenser 9 for dispensing only one ingredient such as water or oil. However, the stir fryer 1 can have multiple dispensers to dispense out each of the ingredients which are required to be used while cooking a dish. In case, if only dispenser 9 is provided than all other ingredients have to be manually picked by the user and have to be dispensed into the cavity of the pot 9. To control dispensing of the ingredients, so that the ingredients are dispensed only according to a particular measurement, an ingredient dispense controller 10 is provided which receives a dispense trigger 11 to control dispensing of the ingredients into the pot 2. This dispense trigger 11 can be generated using an electrical interface by pressing a button or rotating a rotor which generates electrical signal in the form of dispense trigger 11. The other way is to generate the dispense trigger 11 automatically by the microcontroller 15, as disclosed in the current embodiment. Complete automation removes human error and further deskill the cooking process.

In one embodiment, the one or more ingredients dispensers 9 are aligned to the pot is such a way that the one or more dispensers 9 are also tilted with the tilt of the pot 9. One way to do so is by having the same tilting means 6 shall be functionally coupled to the pot 2, as well as, the dispensers 9, such that when the pot 2 moves the dispensers also moves. Other way can be to provide a separate tilting mechanism for the dispensers 9 which tilts the dispensers separately. In such scenario, the user can visualize the tilt angle of the pot 2, and further tilt the dispensers 9 with the same angle by using manual tilting mechanism or through semi-automated means using electrical interface for generating tilting signals for actuating tilting mechanism for the dispensers 9. Such tilting of the dispensers 9 can also be fully automated using a separate tilt trigger being generated by the microcontroller 15 which can read about the recent tilt angle of the pot 2 from a local memory unit, and accordingly generate tilting trigger for tilting the dispenser 9, and send such tilt trigger to the tilting mechanism for the dispensers 9.

The stir fryer 1 is further provided with cleaning fluid dispensers 27 which are placed near to the opening of the pot, so that the cleaning fluid from the dispenser 27 can directly and easily dispensed into the cavity of the pot 2. Where there is only one cleaning fluid to be dispensed, in such scenario only one cleaning fluid dispenser 27 in required. However, in cases, where water, steam, and liquid soap are dispensed during a cleaning operation of the pot, at least 3 cleaning fluid dispensers 27 are required. Similarly, for different cleaning operations different cleaning fluids are required, and accordingly number of cleaning fluid dispensers may vary. In some scenario, there can be powdered soap also dispensed, and in such scenario, another type of dispensers can be used which can dispense powder. To control dispensing of the cleaning fluids, so that the cleaning fluids are dispensed only according to a particular measurement or with a particular pressure, or both, a cleaning dispense controller 28 is provided which receives a cleaning trigger 29 to control at least one of amount of dispensing of the cleaning fluid or pressure of dispensing of the cleaning fluid from the one of more cleaning fluid dispensers 27, or combination thereof. This cleaning trigger 29 can be generated using an electrical interface by pressing a button or rotating a rotor which generates electrical signal in the form of cleaning trigger 29. The other way is to generate the cleaning trigger 29 automatically by the microcontroller 15, as disclosed in the current embodiment. Complete automation removes human error while cleaning the pot.

In one embodiment, the one or more cleaning fluid dispensers 27 are aligned to the pot is such a way that the one or more dispensers 27 are also tilted with the tilt of the pot 2. One way to do so is by having the same tilting means 6 that shall be functionally coupled to the pot 2, as well as, the dispensers 27, such that when the pot 2 moves the dispensers also moves. Other way can be to provide a separate tilting mechanism for the dispensers 27 which tilts the dispensers separately. In such scenario, the user can visualize the tilt angle of the pot 2, and further tilt the dispensers 27 with the same angle by using manual tilting mechanism or through semi-automated means using electrical interface for generating tilting signals for actuating tilting mechanism for the dispensers 27. Such tilting of the dispensers 27 can also be fully automated using a separate tilt trigger being generated by the microcontroller 15 which can read about the recent tilt angle of the pot 2 from a local memory unit, and accordingly generate tilting trigger for tilting the dispenser 27, and send such tilt trigger to the tilting mechanism for the dispensers 27.

In one embodiment, same dispensers 9, 27 are used for dispensing cleaning fluids, as well as, ingredients. Cleaning liquid is enabled to be dispensed at various pressures to remove the stains effectively. Where the dispensing system is same of liquid ingredients and cleaning liquids, different pressures can be applied for different purposes. For example, oil/ghee/butter dispensing can happen at lower pressure from the same dispensers 9, 27 whereas cleaning liquid can be dispensed at higher pressure.

In furtherance, it is significant to mention that rotation of the pot 2 while cleaning is being carried out, substantially enhance the cleaning operation. Hence, the pot 2 shall be rotated, either manually, or through automated means using microcontroller where cleaning trigger also triggers rotational regulator to regulate rotational means too. A combination of rotation of the pot 2, and the dispensing of cleaning fluids allows cleaning liquid to touch the entire cooking surface of the wok. Further, dispensing of the fluids at a pressure along with rotation of the pot 2, further enhances the cleaning operation.

The cleaning fluid dispensers can also be used to dispense steam at higher temperatures to assist in deep cleaning of wok surface.

In furtherance, the pot can be provided with a lid, so as to control the spillage of contents while cleaning.

The stir fryer 1 also has one or more tossing or stirring arrangement 12 which are coupled to the pot 9, These tossing or stirring arrangements 12 can be replaced with specific tossing or stirring arrangements for tossing specific dishes. These tossing or stirring arrangements 12 can either be placed inside the cavity of the pot 2, so that when the pot 2 rotates the tossing or stirring arrangements are also rotated and due to the rotation, the ingredients are tossed by the tossing or stirring arrangement. One possible way is to fix the tossing or stirring arrangements to the wall of the pot 2, Another way is to place the tossing or stirring arrangement 12 in proximity to the cavity of the pot 2 and a head of the tossing or stirring arrangement 12 is adapted to be placed inside the cavity of the pot 2 to toss the ingredients while carrying out a cooking operation whenever is required. In this scenario, the tossing or stirring arrangement can be attached to a part of a frame of the stir fryer 1, or ever it can be attached to an external surface of the stir fryer, and whenever a cooking step requires tossing, the head of the tossing or stirring arrangement 12 can be lowered into the pot, almost to the base of the cavity of the pot 2, so that the tossing can be carried out. It is pertinent to be noted that in one embodiment, further movement of the tossing or stirring arrangement 12 after lowering down may not be required, and the tossing happens due to relative motion between the pot 2 and the tossing or stirring arrangement 12. In another embodiment, the tossing or stirring arrangement 12 is also moved in a predefined motion, so that to further make tossing operation more efficient. In such scenario, to control movement of tossing or stirring arrangement, a tossing controller 13 is provided, which receives tossing trigger 14 to control movement of the tossing or stirring arrangement 12. This tossing controller 13 also helps in controlling movement of the head of the tossing or stirring arrangement 12 for moving in and out of the pot 2.

In one embodiment, the tossing or stirring arrangement 12 also tilts along with the tilting of the pot 9. This embodiment is helpful to keep the tossing or stirring arrangement 12 to be always aligned to the opening of the pot 2. One way to do so is by having the same tilting means 6 shall be functionally coupled to the pot 2, as well as the tossing or stirring arrangement 12, such that when the pot 2 moves the tossing or stirring arrangement 12 also moves. Other way can be to provide a separate tilting mechanism for the tossing or stirring arrangement 12 which tilts the tossing or stirring arrangement 12 separately. In such scenario, the user can visualize the tilt angle of the pot 2, and further tilt the tossing or stirring arrangement 12 with the same angle by using manual tilting mechanism or through semi-automated means using electrical interface for generating tilting signals for actuating tilting mechanism for the tossing or stirring arrangement 12. Such tilting of the tossing or stirring arrangement 12 can also be fully automated using a separate tilt trigger being generated by the microcontroller 15 which can read about the recent tilt angle of the pot 2 from a local memory unit, and accordingly generate tilting trigger for tilting the tossing or stirring arrangement 12 and send such tilt trigger to the tilting mechanism for the tossing or stirring arrangement 12.

The heating means 3 is further coupled to a heat regulator 20 which receives a heating trigger 17 to regulate the heating medium 3 by varying heating quantum or switch on or switch off of the heating medium 3. This heating trigger 17 can be generated using an electrical interface by pressing a button or rotating a rotor which generates electrical signal in the form of heating trigger 17. The other way is to generate the heating trigger 17 automatically by the microcontroller 15, as disclosed in the current embodiment. Complete automation removes human error and deskills the cooking process.

For generating various triggers to control functioning of the stir fryer 1, the microcontroller 15 is provided with the stir fryer 1. The microcontroller 15 generates the tilt trigger 26, a rotational trigger 16, the dispense trigger 11, the tossing trigger 14, a cleaning trigger 29, and a heat trigger 17 to be sent further to the automatic actuator 8, the rotation regulator 5, the dispense controller 10, the tossing controller 13, the heat regulator 20 and the heating means 3 respectively. These triggers are generated based on various inputs received by the microcontroller 15 from an input unit 18, and a temperature data 31 from a temperature sensor 30. The input unit 18 receives a selection input 19 to select a recipe from a selection of recipes and a portion input 21 relating to a quantity of recipe chosen to be cooked during a cooking operation. The microcontroller 15 receives and processes the portion input 21, and the selection input 19 and generates at least the tilt trigger 26, the rotational trigger 16, the dispense trigger 11, the tossing trigger 14, the cleaning trigger 29 and the heat trigger 17. It is pertinent to be noted that in scenario where complete automation for rotation of the pot 2 is not required the rotational trigger 16 need not be generated. Similarly, where the automation of dispensing of ingredients is not required, the dispense trigger 11 need not be generated by the microcontroller 15. In same way, where movement of tossing or stirring arrangement 12 is not required, the tossing trigger 14 is not generated. And, where heating of the pot 2 is not automate, the heat trigger 17 is not generated. Similarly, where tilting of the pot 2 is not required to be automated the tilt trigger 26 is not generated. And, where cleaning of the pot 2 is not required automatically, and is carried out manually or in semi-automatically, such generation of the cleaning trigger 29 is required by the microcontroller 29.

The temperature sensor 30 measures temperature at a given point of time and generates a temperature data 31, and sends the temperature data 31 to the microcontroller. The temperature sensor 2 is placed in proximity or onto the external surface of the pot. The temperature sensor 30 can also be placed in proximity to or on to the inner surface of the pot 2. This temperature data 31 is further sent to the microcontroller 15 which processes it to further generate the heat trigger 17 to control the heating means 3 for maintaining a required temperature at a given point of time when a cooking cycle for a particular dish is being carried out for a given portion of the dish. The arrangement enables the change in temperature of the pot rather quickly. This is to modulate the heat transfer even along the process of cooking a single portion. For example, a dish may take 400 seconds to be fully made with several ingredients to be dispensed at different instants in that 400 seconds. Now, temperature can be controlled as desired at different timestamps for various ingredients to be cooked to perfection in the given preparation time of the dish. The processing of temperature data 31 is significant at beginning of the cooking process of the dish, as the pot 2 may already be at a temperature level after cooking of preceding dish, and hence further management of the heating of the pot 2 is required to optimize the temperature of the pot 2 to a desired level to start cooking a dish. Thereafter, management of the temperature is required during various steps of cooking. It is pertinent to be noted that while beginning of a cooking operation, temperature data 31 is processed along with selection input 19 and portion input 21 to reach a desired level of temperature of pot to start cooking, however at later stages the temperature data 31 is processed alone by the microcontroller 15 at regular intervals of time, so as to control temperature of the pot 2 as desired for each steps of cooking of the dish.

In furtherance, in one embodiment, the microcontroller 15 can only receive the selection input 19 to select a recipe and each recipe is only linked to a predefined portion to be selected, and hence the portion input 21 is not received.

When microcontroller 15 receives a selection of the recipe, the microcontroller 15 generates triggers in predefined fashion as per the rules stored in a local memory of the stir fryer 1. When a recipe selection is received, the microcontroller 15 extracts the specific cooking rules from the local memory and process the rules to generate triggers, so as to control various functional components of the stir fryer 1. In case, if some of the functional components are not automated or linked to microcontroller 15, the microcontroller 15 generates instructions to be displayed on a display (not shown) of the stir fryer, so that the user can carry out such functions on the stir fryer 1 manually. In one embodiment, the instructions are generated along with the ingredient's images for easy reference and quick reception by the user.

In one specific embodiment, where the stir fryer 1 is enabled to only cook one dish only, even the selection input 19 is not required, and as soon the stir fryer 1 is switched on, the microcontroller 15 is activated to cook that specific dish only, and the microcontroller 15 fetched the only rule to cook that specific dish, and process those rules to generate various triggers and/or instructions for cooking the dish.

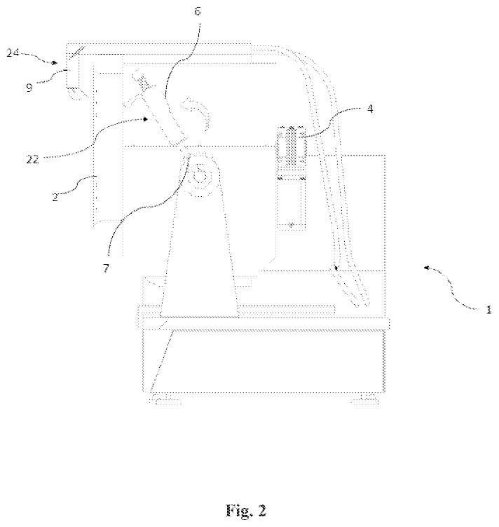

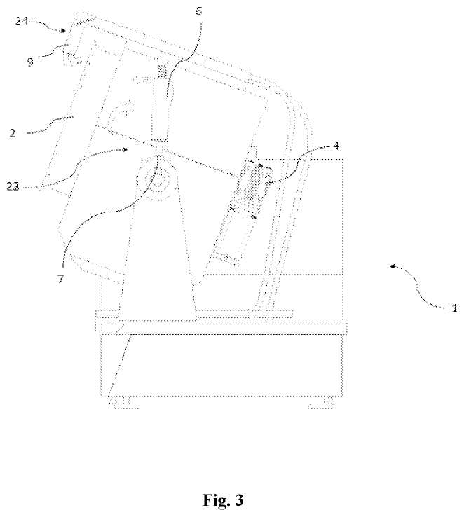

FIG. 2 shows a side view of one embodiment of the stir fryer 1. The stir fryer 1 has a pot 2 having a cavity (not shown). The stir fryer 1 has a lever, as tilting means 6, to tilt the pot 2. The lever 6 is physically attached to the pot 2, and can be rotated to rotate the stir fryer 1. The stir fryer 1 is further provided with a locking means 7. The locking means 7 are achieved through a groove arrangement and an extension of the lever. Various grooves are provided at different tilt angles of the pot 2. To lock the pot 2 at a particular tilt angle, the extension of the lever is engaged into the groove for that particular tilt angle. FIG. 2 shows the pot 2 to be at a first position 22 having the tilt angle of zero degree with respect to base of the stir fryer 1. The stir fryer 1 also has a couple of dispensers 9 aligned to the pot 2. The dispensers 9 can be at two position, in engaged position 24 and disengaged position. In engaged position 24, the dispensers 9 are aligned to the opening of the pot 2, so that the dispensed items can directly move into the cavity of the pot 2. In disengaged position 24, as shown in FIG. 3, mouths of the dispensers are pulled up, so that easy access to inside of the cavity can be provided. The dispensers 9 are physically aligned to the pot 2 such that the dispensers are also moved when the pot is rotated. Such movement of the dispensers can be seen from FIG. 3, where the pot is at a second tilt position 23.

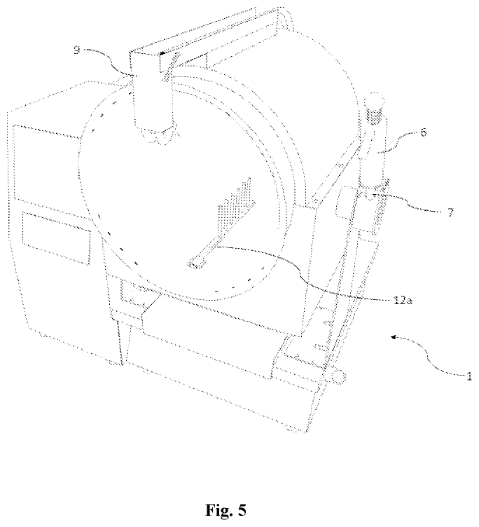

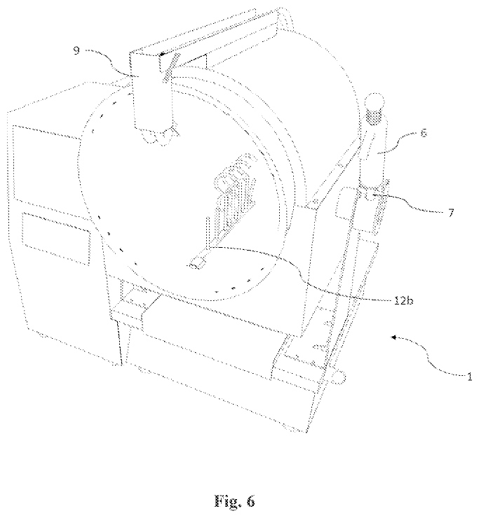

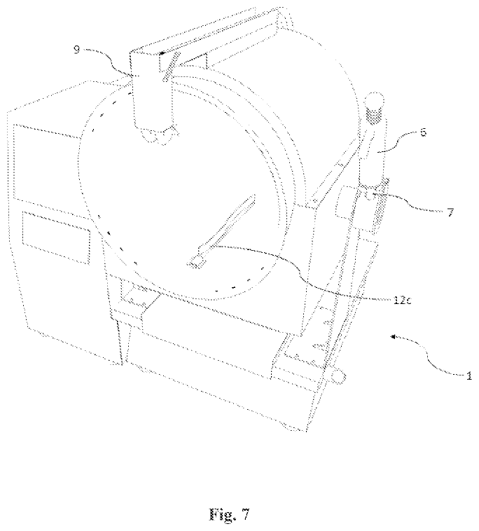

FIGS. 5-7, shows the stir fryer 1 with different types of tossing or stirring arrangements 12a, 12b, 12c for cooking different types of dishes. FIG. 5 shows the stir fryer 1 with the tossing arrangement 12a for cooking rice. FIG. 6 shows the stir fryer 1 with the tossing arrangement 12b for cooking noodles. And FIG. 7 shows the stir fryer 1 with the stirring arrangement 12c for cooking soups. The tossing or stirring arrangements 12a, 12b, 12c are replaceable attached to a side wall of the cavity of the pot 2. The figures also show dispensers 9, the tilting means 6, and the locking means 7 to provide a better visibility of these elements.

In one embodiment, the pot is provided with a lid. The lid when placed airtight on the pot, will be able to control pressure inside the pot. In furtherance, lid also prevents spillage of ingredients while in the cooking process even without additional pressure application. With a combination of rotation of pot, tilting of pot, and pressure/temperature variation inside the work, several dishes are cooked to perfection.

While specific language has been used to describe the invention, any limitations arising on account of the same are not intended. As would be apparent to a person skilled in the art, various working modifications may be made to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

### LIST OF REFERENCE NUMERALS

1 Stir Fryer
2 Pot
3 Heating medium
4 Rotational means
5 Rotation regulator
6 Tilting means
7 Locking means
8 Automatic actuator
9 Ingredient dispenser
10 Dispense controller
11 Dispense trigger
12 Tossing or stirring arrangement
12a Tossing arrangement for rice
12b Tossing arrangement for noodles
12c Stirring arrangement for soup
13 Tossing controller
14 Tossing trigger
15 Microcontroller
16 Rotational trigger
17 Heat trigger
18 Input unit
19 Selection input
20 heat regulator
21 Portion input
22 First tilted position of pot
23 Second tilted position of the pot
24 Engaged position of the dispenser
25 Disengaged position of the dispenser
26 Tilt trigger
27 Cleaning fluid dispenser
28 Cleaning dispense controller
29 Cleaning trigger
30 Temperature sensor
31 Temperature data

1. A stir fryer (1) comprising:
a pot (2) having a cavity to place ingredients to stir fry the ingredients, and adapted to be rotated;
a heating medium (3) functionally coupled to the pot (2) and adapted to heat the pot (2);
a rotational means (4) adapted to be functionally coupled to the pot (2), and adapted to rotate the pot (2) symmetrically or eccentrically about an axis; and
a rotation regulator (5) adapted to regulate the rotational means (4) to further regulate speed of rotation of the pot (2).

2. The stir fryer (1) according to claim 1 comprising:
a tilting means (6) adapted to tilt the pot (2) at a tilt angle up to one hundred and eighty degree from a normal of a base on which the stir fryer (1) is placed.

3. The stir fryer (1) according to claim 2 comprising:
a locking means (7) to lock the pot (2) at a predefined tilt angle, or to unlock the pot (2) to be released from the predefined tilt angle.

4. The stir fryer (1) according to claim 2 comprising:
an automatic actuator (8) adapted to receive and process a tilt trigger (26), and adapted to actuate the tilting means (6).

5. The stir fryer (1) according to claim 1 comprising at least:
one or more ingredients dispensers (9) adapted to place in proximity to the pot (2) and functionally coupled to the pot (2) to dispense ingredients into the cavity of the pot (2).

6. The stir fryer (1) according to claim 5 comprising:
a ingredient dispense controller (10) adapted to receive a dispense trigger (11) and adapted to control dispensing of the ingredients into the pot (2).

7. The stir fryer (1) according to claim 5, wherein the one or more ingredients dispensers (9) are adapted to tilt along with the tilting of the pot (2).

8. The stir fryer (1) according to claim 1 comprising
one or more changeable tossing or stirring arrangements (12) placed inside the cavity of the pot (2).

9. The stir fryer (1) according to claim 1 comprising:
one or more changeable tossing or stirring arrangements (12) placed in proximity to the cavity of the pot (2) and a head of the tossing or stirring arrangement (12) is adapted to placed inside the cavity of the pot (2) to toss the ingredients while carrying out a cooking operation.

10. The stir fryer (1) according to claim 9 comprising:
a tossing controller (13) adapted to receive a tossing trigger (14) and adapted to control movement of the tossing or stirring arrangements (12) into the cavity of the pot.

11. The stir fryer (1) according to claim 9, wherein the one or more tossing or stirring arrangements (12) are adapted to tilt along with the tilting of the pot (2).

12. The stir fryer (1) according to claim 1 comprising:
a heat regulator (20) adapted to receive and process a heat trigger (17) and regulate the heating medium (3) by varying heating quantum or switch on or switch off of the heating medium (3).

13. The stir fryer (1) according to claim 1 comprising:
one or more cleaning fluid dispenser (27) adapted to be placed in proximity to the pot (2) and functionally coupled to the pot (2) to dispense cleaning fluid into the cavity of the pot (2).

14. The stir fryer (1) according to claim 13 comprising:
a cleaning dispense controller (28) adapted to receive a cleaning trigger (29) and adapted to control at least one of amount of dispensing of the cleaning fluid or pressure of dispensing of the cleaning fluid from the one of more cleaning fluid dispensers (27), or combination thereof.

15. The stir fryer (1) according to claim 13, wherein the one or more cleaning fluid dispensers (27) are adapted to tilt along with the tilting of the pot (2).

16. A stir fryer (1) comprising:
a pot (2) having a cavity to place ingredients to stir fry the ingredients, and adapted to be rotated; a heating medium (3) functionally coupled to the pot (2) and adapted to heal the pot (2):
a rotational means (4) adapted to be functionally coupled to the pot (2), and adapted to rotate the pot (2) symmetrically or eccentrically about an axis;
a rotation regulator (5) adapted to regulate the rotational means; (4) to further regulate speed of rotation of the pol (2);
a microcontroller (15) adapted to generate a rotational trigger (16) and optionally a tilt trigger (26), the dispense trigger (11), the tossing trigger (14), the cleaning trigger (29) or the heat trigger (17), or combination thereof, wherein the rotational trigger (16) is received by the rotation regulator (5) to regulate rotational means (4),
the stir fryer optionally comprises:
an automatic actuator (8) adapted to receive and process the tilt trigger (26), and adapted to actuate a tilting means (6) adapted to tilt the pot (2) at a jilt angle up to one hundred and eighty degree from a normal of a base or; which the stir fryer (1) is placed,
an ingredient dispense controller (10) adapted to receive the dispense trigger (11) and adapted to control one or more ingredients dispensers (9) for dispensing of the ingredients into the pot (2),
a tossing controller (13) adapted to receive the tossing trigger (M) and into the cavity of the pot (2), wherein the tossing or stirring arrangements (12) tosses the ingredients white carrying out: a cooking operation,
a heat regulator (20) adapted to receive and process the heat trigger (17) and regulate the heating medium (3) by varying heating quantum or switch on or switch off of the heating medium (3),
a cleaning dispense controller (28) adapted to receive a cleaning trigger (29) and adapted to control amount of dispensing, of the cleaning fluid or pressure of dispensing of the cleaning fluid from one of more cleaning fluid dispensers (27, or both,
combination thereof.

17. The stir fryer (1) according to claim 16 comprising:
one or more temperature sensors (30) adapted to measure temperature at a given point of time, generates a temperature data (31), and adapted to send the temperature data (31) to the microcontroller (15), wherein the microcontroller (15) is adapted to process the temperature data (31) and generate the heat trigger (17) based on such processing.

18. The stir fryer (1) according to claim 16 comprising:
a input unit (18) adapted to receive a selection input (19) to select a recipe from a selection of recipes, wherein the microcontroller (15) is adapted to receive and process the selection input (19), optionally along with the temperature data (31) and adapted to generate at least the tilt trigger (26), the rotational trigger (16), the dispense trigger (11), the tossing trigger (14), the cleaning trigger (29), or the heat trigger (17), or combination thereof.

19. The stir fryer (1) according to claim 18, wherein the input unit (18) is adapted to receive a portion input (21), or combination thereof, wherein the portion input (21) relates to a quantity of recipe chosen to be cooked during a cooking operation, and wherein the microcontroller (15) is adapted to receive and process the portion input (21) along with the selection input (19), and optionally along with the temperature data (31), and adapted to generate at least the tilt trigger (26), the rotational trigger (16), the dispense trigger (11), the tossing trigger (14), the cleaning trigger (29) or the heat trigger (17), or combination thereof.
